(19) United States
(12) Patent Application Publication
(10) Pub. No.: US 2025/0229134 A1
(43) Pub. Date: Jul. 17, 2025

(54) DEVICES, SYSTEMS, AND METHODS TO GENERATE EXERCISE PROGRAM RECOMMENDATIONS

(71) Applicant: iFIT Inc., Logan, UT (US)

(72) Inventors: Chase Brammer, Providence, UT (US); Mark Matthew Archer, Cathedral City, CA (US); Trevor Dylan Facer, Millville, UT (US); Robert Lee Plummer, Greenwood, IN (US)

(21) Appl. No.: 19/012,046

(22) Filed: Jan. 7, 2025

Related U.S. Application Data
(60) Provisional application No. 63/620,614, filed on Jan. 12, 2024.

(51) Int. Cl. A63B 24/00; A63B 71/06; G06V 10/70

(52) U.S. Cl. CPC A63B 24/0075; A63B 71/0622; G06V 10/70

(57) ABSTRACT

An exercise program recommendation system may apply a vector search model to a plurality of exercise program videos, the vector search model identifying vector features within the plurality of exercise program videos. An exercise program recommendation system may receive a search query for an exercise program, the search query including an exercise program feature. An exercise program recommendation system may be based on the exercise program feature, applying a machine learning (ML) personalization model to the plurality of exercise program videos. An exercise program recommendation system may provide a user with an exercise program recommendation from the plurality of exercise program videos.

### CROSS REFERENCE

This application claims the benefit and priority to U.S. Patent Application No. 63/620,614, filed Jan. 12, 2024, which is incorporated herein by reference in its entirety for all that it discloses.

### BACKGROUND

Health is a critical part of a person's well-being. People cultivate their health through health actions, including exercise, diet, lifestyle, and so forth. People may use exercise systems to facilitate their health journey. Conventional exercise systems may provide health recommendations to a person based on pre-determined responses to the person's requests. For example, a user that desires to lose weight and participate in a 5 kilometer race may receive a pre-determined diet and exercise system. But such predetermined systems are inflexible. Indeed, such plans may be inapplicable to some user's lifestyle, attitude, motivational styles, and so forth.

In some situations, indoor exercise has increased in popularity and accessibility. Many people exercise indoors with the aid of an exercise device. Exercise devices may be designed to simulate outdoor exercise activities, such as a treadmill to simulate running, a stationary bicycle to simulate cycling, or a rower to simulate rowing. Additionally, or alternatively, exercise devices may be designed to exercise a certain muscle or muscle group, reduce the impact or force applied to the user, aid in certain types of indoor exercises, perform any other function, and combinations thereof.

Many exercise devices facilitate playing or implementing an exercise program on the exercise device. The exercise program may include operating information for the exercise device and some interactive features. The interactive features may include videos, including videos of trainers and/or virtual environments. The exercise programs are often stored in an exercise program library. But exercise program libraries may store massive amounts of exercise programs. This may make identifying, searching, and finding exercise programs of interest to a user difficult.

### SUMMARY

In some aspects, the techniques described herein relate to a method for generating exercise program recommendations. An exercise program recommendation system applies a vector search model to a plurality of exercise program videos. The vector search model identifies vector features within the plurality of exercise program videos. The exercise program recommendation system receives a search query for an exercise program. The search query includes an exercise program feature. Based on the exercise program feature, the exercise program recommendation system applies a machine learning (ML) personalization model to the plurality of exercise program videos. The exercise program recommendation system provides a user with an exercise program recommendation from the plurality of exercise program videos.

In some aspects, the techniques described herein relate to a method for generating exercise program recommendations. An exercise program recommendation system receiving a plurality of exercise programs from an exercise program library. The plurality of exercise programs include video features of exercise program videos associated with the plurality of exercise programs. The exercise program recommendation system applies a vector search model to the plurality of exercise programs. The vector search model generates vector features for the video features. The exercise program recommendation system identifies top video features from a user exercise program history. The exercise program recommendation system applies a machine learning (ML) personalization model to the plurality of exercise programs to generate an exercise program recommendation from the plurality of exercise programs based on the top video features.

This summary is provided to introduce a selection of concepts that are further described below in the detailed description. This summary is not intended to identify key or essential features of the claimed subject matter, nor is it intended to be used as an aid in limiting the scope of the claimed subject matter. Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a schematic representation of an exercise program recommendation system, according to at least one embodiment of the present disclosure.

FIG. 2 is a schematic representation of an exercise program recommendation system, according to at least one embodiment of the present disclosure.

FIG. 3 is a representation of a string diagram of an exercise program recommendation system, according to at least one embodiment of the present disclosure.

FIG. 4 is a flowchart of a method for generating exercise program recommendations, according to at least one embodiment of the present disclosure.

FIG. 5 is a flowchart of a method for generating exercise program recommendations, according to at least one embodiment of the present disclosure.

FIG. 6 is a schematic representation of a computing system, according to at least one embodiment of the present disclosure.

### DETAILED DESCRIPTION

This disclosure generally relates to devices, systems, and methods for providing exercise program recommendations for a user of an exercise device. An exercise program recommendation system may review the exercise program videos used in exercise programs stored in an exercise program library. The exercise program recommendation system may apply a vector search model to the exercise program videos. This may result in vectored features of the exercise program videos. The vectored features may be associated with video features, such as background features, trainer features, and so forth. The exercise program recommendation system may apply a machine learning (ML) personalization model to the exercise program videos to generate a recommended exercise program video for the user to use in a workout. The ML personalization model may utilize the vectored features to determine the recommended exercise program video for the user. In this manner, the recommended exercise program videos may be more relevant and/or more representative of the user's interests and preferences in exercise programs. This may help to improve the exercise experience for the user.

In accordance with at least one embodiment of the present disclosure, the ML personalization model prepares the recommended exercise videos based on user information. For example, the user may login with a user login to an exercise machine with a user profile. The user profile may include an exercise program history, which may be a representation of the completed exercise programs that the user has previously completed. The exercise program history may include the top video features for the user. The exercise program videos from the completed exercise programs may have been vectorized by the vector search model. Using the vector features from the vectorized completed exercise programs, the user profile may include a list vector features from the completed exercise program videos. In some embodiments, the user profile includes a list of common or favorite vector features, such as a count of how many workouts the user performed with an exercise program that included that particular vector features. Using the common or favorite vector features, the ML personalization model may prepare exercise program recommendations for the user using the vector features of the exercise program videos associated with the exercise programs in the exercise program library. In this manner, the recommended exercise programs may include exercise program videos that include vectored features that the user likes or regularly uses. This may facilitate improved recommendations, resulting in increased user engagement with exercise and exercise programs.

In some embodiments, the ML personalization model prepares exercise program recommendations based on a query. For example, the user may enter a query when the user desires to perform a workout on an exercise device. The ML personalization model may identify keywords from the query and recommend exercise programs based on exercise programs that include exercise program videos with exercise features associated with the query keywords. In some embodiments, the query may be an automated search query. For example, when the user logs in to the exercise device, the operating system for the exercise device may send a query to the ML personalization model to prepare an exercise program recommendation based on the user's exercise program history. In this manner, the user may receive exercise program recommendations without actively entering a query. This may facilitate improved engagement in exercise programs and improve the exercise experience.

In some embodiments, the ML personalization model prepare workout recommendations. For example, the ML personalization model may prepare workout recommendations for the user to perform a particular workout or series of workouts. The recommended workouts may be based on the analyzed exercise information. In some embodiments, the techniques described herein may be applied to workout recommendations for exercise activities that are not performed on an exercise device.

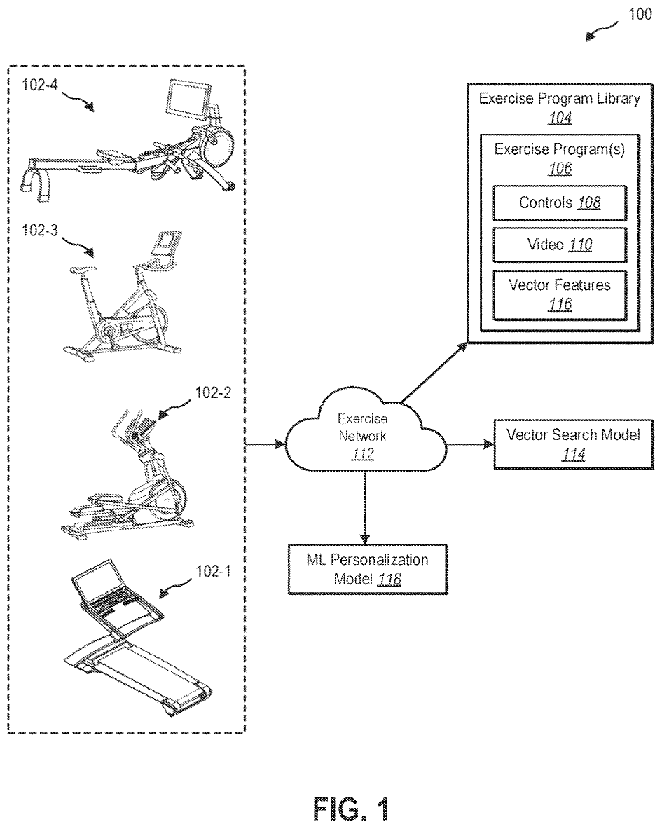

FIG. 1 is a schematic representation of an exercise program recommendation system 100, according to at least one embodiment of the present disclosure. As discussed herein, the exercise program recommendation system 100 may provide exercise program recommendations to a user using an ML personalization model applied to exercise programs that have been vectorized by a vector search model.

The exercise program recommendation system 100 may include one or more exercise devices (collectively 102). The exercise devices 102 may include any type of exercise device, such as a treadmill 102-1, an elliptical device 102-2, a stationary bicycle 102-3, a rower 102-4, a cable extension device, a mirror including a backlit display behind a mirrored surface, any other exercise device, and combinations thereof. While specific exercise devices 102 are illustrated and discussed herein, it should be understood that the techniques of the present disclosure may be applied to any exercise device that is capable of implementing an exercise program.

The exercise program recommendation system 100 may further include an exercise program library 104. The exercise program library 104 may include a repository of one or more exercise programs 106. The exercise programs 106 may be implemented on one or more of the exercise devices 102. Each of the exercise programs 106 may include exercise device controls 108 and an exercise program video 110.

When the user accesses the exercise program 106 on an exercise device 102, the exercise program 106 may guide the user through a workout. Throughout the workout, the exercise device controls 108 may adjust one or more operating parameters of the exercise device 102. The exercise device controls 108 may adjust any operating parameter, such as a flywheel resistance, a belt speed, a device incline, any other operating parameter, and combinations thereof. In some embodiments, the exercise device controls 108 include a duration for one or more portions of the exercise program. For example, the exercise device controls 108 may include a total workout duration for the entire exercise program 106 and/or an interval duration for a period of a particular difficulty level (e.g., resistance level, belt speed, incline level).

The exercise programs 106 may include an exercise program video 110. The exercise program video 110 may be a video that is associated with the workout. When the user accesses the exercise program on an exercise device 102, the exercise program video 110 may be displayed on a display of the exercise device. The exercise program video 110 may include any type of video. For example, the exercise program video 110 may include a representation of a trainer that is providing instruction for the user to perform the workout. In some examples, the trainer in the exercise program video 110 may be performing the workout in the exercise program video 110. In some examples, the exercise program video 110 may include scenery and/or setting images. The scenery may include any type of scenery, such as outdoor scenes, scenes representative of real-world locations, scenes representative of fantasy locations, any other scenery, and combinations thereof. In some embodiments, the scenery and/or setting includes videos. In some embodiments, the scenery and/or setting includes still backgrounds. In some embodiments, the trainer is depicted as being located in front of the scenery. In some embodiments, the trainer is recorded on-site in front of the scenery. In some embodiments, the trainer is recorded remote from the scenery and overlaid in front of the scenery.

The exercise program video 110 may be synchronized with the exercise device controls 108. For example, the exercise program video 110 may include video features, audio features, or other elements that are synchronized or associated with the exercise device controls 108. The associations between the exercise program video 110 and the exercise device controls 108 may be based on any portion of the exercise program video 110. For example, the associations between the exercise program video 110 and the exercise device controls 108 may be based on comments made by the trainer. In some examples, the associations between the exercise program video 110 and the exercise device controls 108 may be based on the operating parameters of the trainer's exercise device. In some examples, the associations between the exercise program video 110 and the exercise device controls 108 may be based on the scenery (e.g., increased incline when a hill is depicted).

In some embodiments, the exercise programs 106 are specifically tailored to a particular exercise device 102. For example, the exercise programs 106 may be specifically tailored to a type of exercise device 102, a manufacturer of an exercise device 102, a particular model of exercise device 102, and so forth. The exercise device controls 108 may be specific to control the particular exercise device 102. In some examples, the exercise program video 110 may include features, references, or images depicting a particular exercise device 102.

In some embodiments, the exercise programs 106 are usable by more than one type of exercise device 102. For example, an exercise program 106 may include resistance settings for a flywheel, and the exercise program 106 may be usable by any flywheel-based exercise device 102. In some embodiments, a portion of an exercise program is usable by multiple exercise programs 106. For example, an exercise program video 110 may include scenery over which a trainer may be overlaid. Different trainers operating different exercise devices 102 and/or performing different exercise activities may be overlaid over the same scenery to make the exercise program video 110.

In some embodiments, the exercise program library 104 is at least partially stored on the individual exercise devices 102. For example, one or more of the exercise programs 106 may be stored on memory of the exercise devices 102. In some embodiments, the exercise program library 104 is stored in memory on a remote computing device, such as a server computing device, a cloud computing system, any other remote computing device, and combinations thereof.

The exercise devices 102 may be in communication with the exercise program library 104 over an exercise network 112. The exercise network 112 may be any type of network. For example, the exercise network 112 may be a local area network (LAN), a wide area network (WAN), a Wi-Fi network, a cellular network, any other network, and combinations thereof.

The exercise program recommendation system 100 may further include a vector search model 114. The vector search model 114 may access or receive one or more of the exercise programs 106 from the exercise program library 104. In some embodiments, the vector search model 114 receives the entirety of the exercise program library 104, or the entirety of the exercise programs 106 in the exercise program library 104. The exercise program recommendation system 100 may apply the vector search model 114 to the exercise programs 106. In accordance with at least one embodiment of the present disclosure, the vector search model 114 vectorizes at least a portion of the exercise programs 106. The exercise program recommendation system 100 may apply the vector search model 114 to the exercise programs 106 to analyze the content of the exercise programs 106. In this manner, the exercise program library 104 may include a library of the vectorized content of the exercise programs 106.

The vector search model 114 may prepare vector embeddings of vector features 116 in the exercise programs 106. To generate the vector features 116, the vector search model 114 may be trained on a training dataset including videos tagged with key features or tags. The key features or tags may be relevant to the exercise program videos 110. For example, the key features or tags may include background features, scenery features, trainer features (e.g., gender, race, intensity), any other vector features 116 of the exercise program videos 110, and combinations thereof.

When the exercise program recommendation system 100 applies the vector search model 114 to the exercise programs 106, the vector search model 114 may generate one or more exercise features 116 for each of the exercise programs 106. In some embodiments, each exercise program 106 includes one vector feature 116. In some embodiments, each exercise program 106 includes multiple vector features 116. In some embodiments, the vector features 116 of the exercise programs 106 is ranked based on a prevalence of the vector features 116 within the exercise programs 106. For example, the vector features 116 may be ranked based on how frequently a particular vector feature 116 is present in the exercise program 106. In some examples, the vector features 116 may be ranked based on a total duration or a percent duration the particular vector feature is present in the exercise programs 106. Ranking the vector features 116 may help to indicate the prevalence of the vector features 116 in the exercise program.

The exercise program recommendation system 100 may further include an ML personalization model 118. The exercise program recommendation system 100 may apply the ML personalization model 118 to user information and/or user queries to generate an exercise program recommendation for the user to perform on a particular exercise device 102. To generate the exercise program recommendations, the ML personalization model 118 may analyze the exercise programs 106 to determine the similarity of the exercise programs 106 to the queries. For example, the ML personalization model 118 may determine the vector features 116 that are close or similar to the user information and/or the user query. Based on the similarities, the ML personalization model 118 may generate the exercise program recommendation.

The ML personalization model 118 may be any type of personalization model and may utilize any personalization mechanisms to generate the recommendations. For example, the ML personalization model 118 may use collaborative filtering based on the exercise program history of multiple users. This may help to identify patterns between exercise programs 106 that other users may enjoy or desire. In some examples, the ML personalization model 118 may utilize content-based filtering. Content-based filtering may filter the exercise programs 106 based on the vector features 116 in the exercise programs 106. In some examples, content-based filtering may examine other media with which the user interacts to provide recommendations. In some examples, the ML personalization model 118 may utilize natural language processing to process input queries, conversations, or other natural language provided by the user. In some examples, the ML personalization model 118 may utilize A/B testing to determine the effectiveness of different recommendation strategies. In some embodiments, the ML personalization model 118 incorporates contextual information to provide recommendations, such as time of day, time of year, type of exercise device, workout intensity history, user location, user proximity to other users, any other contextual information, and combinations thereof. In some examples, the ML personalization model 118 may be a trainable ML model trained based on user ratings of exercise programs. In some examples, the ML personalization model 118 may utilize a combination of two or more of the techniques discussed herein.

In some embodiments, the ML personalization model 118 generates a single exercise program recommendation. For example, the ML personalization model 118 may generate the exercise program recommendation that the ML personalization model 118 determines is the best fit for the user. In some embodiments, the ML personalization model 118 generates multiple exercise program recommendations. For example, the ML personalization model 118 may generate a plurality of exercise program recommendations based on a minimum threshold of similarity to the query or user information. In some embodiments, the ML personalization model 118 generates a ranking for each exercise program recommendation. The ranking may be a similarity recommendation. For example, the ranking may be a representation of how similar the exercise program recommendation is to a previously performed exercise program. In some embodiments, the ranking is a projected interest ranking. For example, the ranking may be a representation of a projected ranking or enjoyment of the recommended exercise program. In some embodiments, the ranking is based on the vector features 116, including the similarity of the vector features 116 to the user information and/or the user query.

The ML personalization model 118 may provide the exercise program recommendation to the user on the exercise device 102. In some embodiments, the ML personalization model 118 provides the exercise device 102 with the exercise program recommendation and the exercise device 102 may provide the exercise program recommendation to the user on a display of the exercise device 102.

In some embodiments, the exercise program recommendation system 100 implements the recommended exercise program 106 on the exercise device 102. In some embodiments, the user selects the recommended exercise program 106, and upon receiving the selection of the exercise program, the exercise program recommendation system 100 may implement the recommended exercise program 106 on the exercise device 102. The user may then perform the workout on the exercise device 102 using the recommended exercise programs 106.

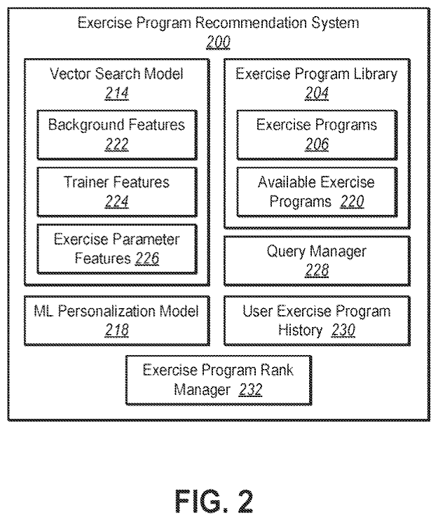

FIG. 2 is a representation of an exercise program recommendation system 200, according to at least one embodiment of the present disclosure. Each of the components of the exercise program recommendation system 200 can include software, hardware, or both. For example, the components can include one or more instructions stored on a computer-readable storage medium and executable by processors of one or more computing devices, such as a client device or server device. When executed by the one or more processors, the computer-executable instructions of the exercise program recommendation system 200 can cause the computing device(s) to perform the methods described herein. Alternatively, the components can include hardware, such as a special-purpose processing device to perform a certain function or group of functions. Alternatively, the components of the exercise program recommendation system 200 can include a combination of computer-executable instructions and hardware.

Furthermore, the components of the exercise program recommendation system 200 may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

The exercise program recommendation system 200 includes an exercise program library 204. The exercise program library 204 includes a storage of exercise programs 206 that may be implemented on an exercise device, as discussed above with respect to the exercise program library 104 of FIG. 1. The exercise program library 204 may further include available exercise programs 220. The available exercise programs 220 may be exercise programs that are available to the user. For example, the available exercise programs 220 may include exercise programs that are available to the user based on a subscription plan of the user. In some examples, the available exercise programs 220 may be device-specific exercise programs, or exercise programs that are available to the user based on the user's exercise device. In some examples, the available exercise programs 220 may be available to the user in any other manner.

The exercise program recommendation system 200 may further include a vector search model 214. The vector search model 214 may vectorize one or more of the exercise programs 206 in the exercise program library 204. The vector search model 214 may generate vector features of the exercise programs 206 based on any exercise program feature. For example, the vector search model 214 may generate vector features based on background features 222 of the exercise program video. In some examples, the vector search model 214 may generate the vector features based on trainer features 224 of the trainer featured in the exercise program video. In some examples, the vector search model 214 may generate the vector features based on exercise parameter features 226, such as exercise program length, difficulty, average resistance, average incline, heart rate targets, any other exercise parameter feature, and combinations thereof.

The exercise program recommendation system 200 may include an ML personalization model 218. As discussed herein, the ML personalization model 218 may generate personalized recommendations for the user based on the vectorized exercise programs 206.

A query manager 228 may receive and manage queries for exercise programs. For example, the query manager 228 may receive an input query input by the user. The input query may be an express input from the user. For example, the user may provide an input to the exercise device or other computing device for exercise programs having one or more particular features. The query manager 228 may provide the ML personalization model 218 with the input query, and the ML personalization model 218 may generate a personalized recommendation to the user based on the query. For example, the ML personalization model 218 may identify exercise features within the query, and may generate the exercise program recommendation to include exercise programs 206 that are similar to the exercise features in the query. In some embodiments, the query is a query for a new exercise program. For example, the new exercise program may be an exercise program that the user has not completed. In some examples, the new exercise program may be an exercise program that includes a new features, or features not included in completed exercise programs.

As a specific, non-limiting example, the query manager 228 may receive an input query from a user on a treadmill where the user states “I would like to go for a run in the mountains.” The ML personalization model 218 may identify that the query is for a treadmill and that the user desires to have features in the exercise program video related to mountains. As discussed herein, the vector search model 214 may identify vector features of the exercise programs 206. The vector features may include exercise program features such as exercise program videos that include mountains, hills, scenic views. The ML personalization model 218 may provide exercise program recommendations based on the exercise programs that have vector features related to mountains.

In some embodiments, the ML personalization model 218 generates the exercise program recommendation based on exercise programs of other users who engage in exercise programs with exercise features having mountains. Such exercise program recommendations may include features related to mountains, but may not include mountains themselves. For example, users that engage in exercise programs with exercise features having mountains may also engage in exercise programs with exercise features having forests. Based on this correlation, the ML personalization model 218 may generate exercise program recommendations that include forested exercise features.

In some embodiments, the ML personalization model 218 generates the exercise program recommendation based at least partially on a user exercise program history 230. The user exercise program history 230 may include a record of the exercise programs performed by the user. For example, the user exercise program history 230 may include a record of each exercise program performed by the user, the date and time the exercise program was performed, the user's rating and other notes about the workout, the user's rating of the exercise program, user parameters related to the exercise programs (e.g., heartrate, cadence), vector features of the exercise program, any other exercise program information, and combinations thereof. The user exercise program history 230 may include top video features. In some embodiments, the top video features include video features that are commonly present in the exercise programs of the user exercise program history 230. In some embodiments, the top video features include video features that are highly rated and/or video features that are present in highly rated exercise programs. In some embodiments, the top video features may include any video feature in the exercise programs from the user exercise program history 230.

The ML personalization model 218 may generate the exercise program recommendations based at least on part on the user exercise program history 230. For example, the ML personalization model 218 may generate the exercise program recommendations based the most common vector features present in the user exercise program history 230. In some examples, the ML personalization model 218 may generate the exercise program recommendations based on the highest rated exercise programs. In some examples, the ML personalization model 218 may generate the exercise program recommendations based when previously completed exercise programs were performed. For example, the ML personalization model 218 may generate an exercise program recommendation for a lower-intensity exercise program if the user recently completed a higher-intensity exercise program. In this manner, the ML personalization model 218 may generate more relevant and/or more representative exercise program recommendations, thereby improving the exercise experience.

In accordance with at least one embodiment of the present disclosure, the query manager 228 may generate a query for the ML personalization model 218 based on the user exercise program history 230. For example, when the user logs into the exercise device, the query manager 228 may review the user exercise program history 230 and generate a query to exercise programs similar to the previously completed exercise programs. The query manager 228 may automatically provide the query to the ML personalization model 218, and the ML personalization model 218 may generate the recommendation. In this manner, the exercise program recommendation system 200 may generate exercise program recommendations without user input.

The exercise program recommendation system 200 may rank the exercise program recommendations. In some embodiments, the ML personalization model 218 provides a ranking for the exercise program recommendations. For example, as discussed herein, the ML personalization model 218 may provide a ranking for the exercise program recommendation, such as a similarity ranking and/or a projected interest ranking. In some embodiments, an exercise program rank manager 232 prepares the ranking. In some embodiments, the exercise program rank manager 232 receives a plurality of exercise program recommendations and the exercise program rank manager 232 may rank the plurality of exercise recommendations.

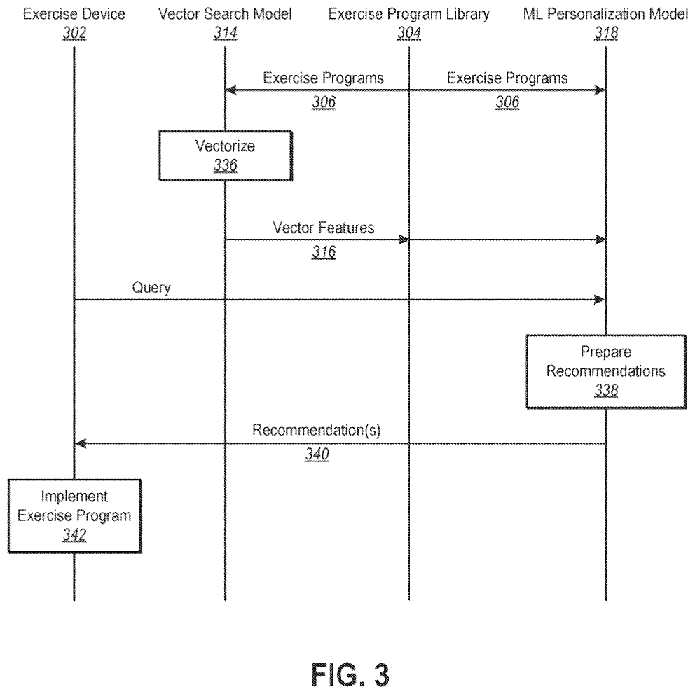

FIG. 3 is a representation of a string diagram 334 of an exercise program recommendation system, according to at least one embodiment of the present disclosure. An exercise program library 304 may include a repository of exercise programs 306. A vector search model 314 may be applied to the exercise programs 306. As discussed herein, the vector search model 314 may vectorize the exercise programs 306 to generate the vector features 316 of the exercise programs 306.

The exercise program recommendation system may further include a ML personalization model 318. The ML personalization model 318 may receive the exercise programs 306 and/or the vector features 316 of the exercise programs 306.

When the user desires to begin a workout, the user may log into or otherwise access an exercise device 302. The exercise device 302 may provide a query 336 to the ML personalization model 318. As discussed herein, the query 336 may include any type of query. For example, the user may provide an input to the exercise device 302. In some examples, the exercise device 302 may generate an input based on user information and/or user exercise program history.

The ML personalization model 318 may receive the query 336. The ML personalization model 318 may process the query 336 and prepare 338 one or more exercise program recommendations 340. The ML personalization model 318 may send the exercise program recommendations 340 to the exercise device 302.

The exercise device 302 may receive the one or more exercise program recommendations 340. Based on the exercise program recommendations 340, the exercise device 302 may implement 342 the exercise program associated with the exercise program recommendations 340. For example, the exercise device 302 may cause the exercise device 302 to display the video portion of the exercise program and to adjust the operating parameters of the exercise device 302 based on the exercise device controls. In some embodiments, the user selects one of the exercise program recommendations 340 and the exercise device 302 may implement the exercise program associated with the selected exercise program recommendation.

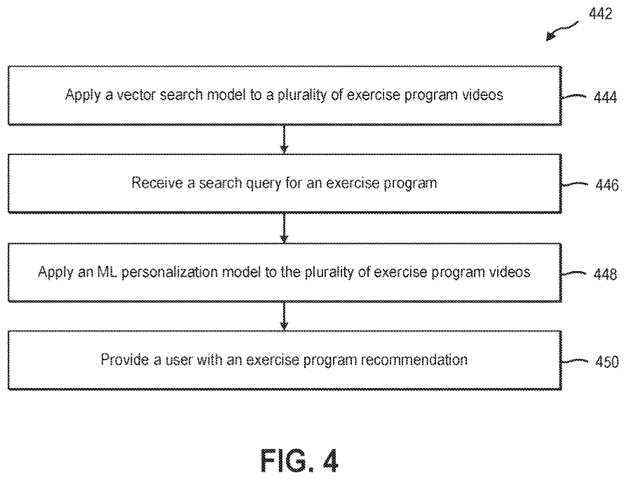

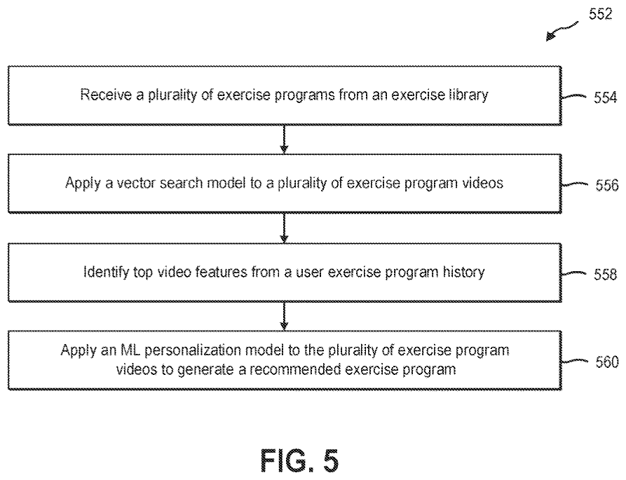

FIGS. 4-5, the corresponding text, and the examples provide a number of different methods, systems, devices, and computer-readable media of the exercise program recommendation system 200. In addition to the foregoing, one or more embodiments can also be described in terms of flowcharts comprising acts for accomplishing a particular result, as shown in FIG. 4-5. FIG. 4-5 may be performed with more or fewer acts. Further, the acts may be performed in differing orders. Additionally, the acts described herein may be repeated or performed in parallel with one another or parallel with different instances of the same or similar acts.

As mentioned, FIG. 4 illustrates a flowchart of a series of acts or a method 442 for generating exercise program recommendations, according to at least one embodiment of the present disclosure. While FIG. 4 illustrates acts according to one embodiment, alternative embodiments may omit, add to, reorder, and/or modify any of the acts shown in FIG. 4. The acts of FIG. 4 can be performed as part of a method. Alternatively, a computer-readable medium can comprise instructions that, when executed by one or more processors, cause a computing device to perform the acts of FIG. 4. In some embodiments, a system can perform the acts of FIG. 4.

The exercise program recommendation system 200 may apply a vector search model to a plurality of exercise program videos at 444. The vector search model may identify vector features within the plurality of exercise program videos. For example, the vector search model may identify vector features related to video features in the exercise program videos. The exercise program videos may be associated with exercise programs. For example, an exercise program video may be displayed during the execution of an exercise program.

The exercise program recommendation system 200 may receive a search query for an exercise program at 446. The search query may include an exercise program feature. For example, the search query may include an input query using input from the user, and the input query may include a request for a particular exercise program feature. In some examples, the search query may be an automatic search query that is generated based on user exercise information in the user exercise program history. The exercise program features in the search query may include any exercise program features, such as background features of an exercise program video, exercise intensity, trainer features, prior workouts performed, user exercise program ratings, any other exercise program features, and combinations thereof.

Based on the exercise program feature in the search query, the exercise program recommendation system 200 may apply an ML personalization model to the plurality of exercise program videos at 448. The ML personalization model may sort the exercise programs based on the query and using the vector features. The ML personalization model may generate an exercise program recommendation. For example, the ML personalization model may generate the exercise program recommendation from the plurality of exercise program videos. The exercise program recommendation system 200 may provide the user with the exercise program recommendation from the plurality of exercise program videos at 450.

In accordance with at least one embodiment of the present disclosure, the exercise program recommendation system 200 implements or causes to be implemented the exercise program recommendation on an exercise device. For example, the user may select the recommended exercise program and the exercise device may implement the recommended exercise program on the exercise device.

In some embodiments, the exercise program recommendation includes a plurality of exercise program recommendations. For example, the ML personalization model may generate a plurality of exercise program recommendations based on the query and using the vectored features. The ML personalization model may generate multiple exercise program recommendations and the exercise program recommendation system 200 may provide the exercise program recommendations to the user. In some embodiments, the user selects one of the recommended exercise programs and the exercise program recommendation system 200 may cause the selected exercise program to be implemented on the exercise device.

In some embodiments, the ML personalization model generates the exercise program recommendation using a user exercise program history. The user exercise program history may include historical exercise information for the user. In some embodiments, the user exercise program history includes top video features from previously performed or completed exercise programs.

In some embodiments, the ML personalization model identifies correlations between the vector features and user popularity. The user popularity may be the popularity of the exercise programs as indicated by how frequently the exercise program is performed by other users and/or the number of other users that have performed a particular exercise program. In some embodiments, the ML personalization model 218 generates the exercise program recommendation based on the vector features and the user popularity.

In some embodiments, when generating the vector features, the vector search model utilizes pre-determined vector features. For example, as discussed herein, the vector search model may be trained using the pre-determined vector features. Applying the vector search model to the based on the pre-determined vector features. This may cause the vector search model to generate the vector features for the exercise program library that correlate to and/or include the pre-determined vector features.

In some embodiments, the exercise program recommendation system 200 gathers a set of exercise program videos and the ML personalization model may prepare the exercise program recommendation based on the gathered set of exercise. For example, the exercise program recommendation system 200 may gather the set of exercise program videos and the exercise program recommendation system 200 may apply the ML personalization model to the gathered set of exercise program videos.

The exercise program recommendation system 200 may gather the exercise program videos using any gathering parameter. For example, the exercise program recommendation system 200 may gather the set of exercise program videos based on an intensity level of the exercise program videos. In some examples, the exercise program recommendation system 200 may gather the set of exercise program videos based on trainer information, such as a trainer identity. In some examples, the exercise program recommendation system 200 may gather the set of exercise program videos based on exercise program availability. The exercise program availability may be a representation of whether a particular user may have access to a particular exercise program. For example, the exercise program availability may be based on a subscription of the user. In some examples, the exercise program availability may be based on the exercise device, including the type of exercise device, the make of the exercise device, the model of the exercise device, any other exercise device information, and combinations thereof. In some examples, the exercise program recommendation system 200 may gather the set of exercise program videos based on a compatibility with a training plan for the user. For example, the training plan for the user may include particular workout types that are to be performed on particular days, such as recovery days, high-intensity days, cross-training days, any other training plan information, and combinations thereof. In some examples, the exercise program recommendation system 200 may gather the set of exercise program videos based on uncompleted exercise programs, or exercise programs that the user has not completed.

As mentioned, FIG. 5 illustrates a flowchart of a series of acts or a method 552 for generating exercise program recommendations, according to at least one embodiment of the present disclosure. While FIG. 5 illustrates acts according to one embodiment, alternative embodiments may omit, add to, reorder, and/or modify any of the acts shown in FIG. 5. The acts of FIG. 5 can be performed as part of a method. Alternatively, a computer-readable medium can comprise instructions that, when executed by one or more processors, cause a computing device to perform the acts of FIG. 5. In some embodiments, a system can perform the acts of FIG. 5.

The exercise program recommendation system 200 may receive a plurality of exercise programs from an exercise library at 554. The plurality of exercise programs may include video features of exercise program videos associated with the plurality of exercise programs. The exercise program recommendation system 200 may apply a vector search model to the plurality of exercise program videos at 556. The vector search model may generate vector features for the video features of the exercise program videos.

The exercise program recommendation system 200 may identify top video features from a user exercise program history at 558. For example, as discussed herein, the exercise program recommendation system 200, including the ML personalization model, may identify the top video features based on any metric, such as number of views/uses, video ranking, any other metric, and combinations thereof.

In some embodiments, the exercise program recommendation system 200 applies an ML personalization model to the plurality of exercise program videos to generate a recommended exercise program from the plurality of exercise programs based on the top video features at 560.

As discussed herein, the exercise program recommendation system 200 may implement the recommended exercise program associated with the exercise program recommendation on an exercise device. In some embodiments, the video features of the exercise program videos include video background features. The video background features may be background features of the exercise program video associated with a particular exercise program. In some embodiments, the ML personalization model 218 generates the vector features for the video background features. In some embodiments, the top video features include top background features, and identifying the top video features includes identifying the top background features.

As discussed herein, in some embodiments, identifying the top video features includes identifying the top video features based on common video features in the user exercise program history. In some embodiments, identifying the top video features includes identifying the top video features based on a completion frequency of the completed exercise programs in the user exercise program history.

In some embodiments, the user exercise program history includes negative video features. In some embodiments, the negative video features are based on any metric, such as uncompleted exercise programs, low user-rankings of exercise programs, user reviews, any other metric, and combinations thereof.

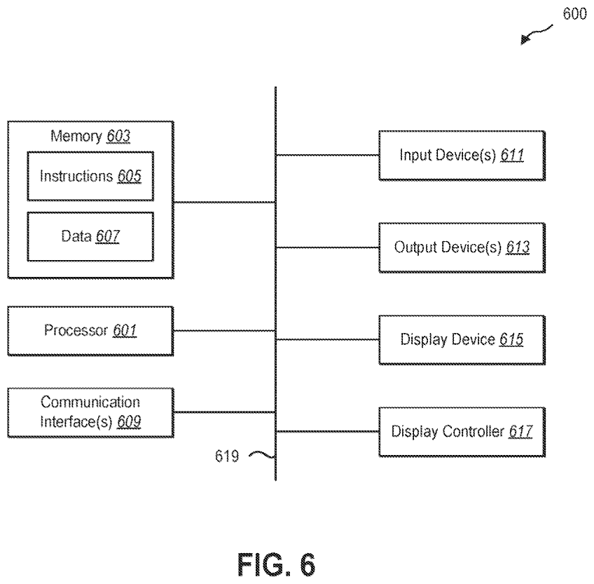

FIG. 6 illustrates certain components that may be included within a computer system 600. One or more computer systems 600 may be used to implement the various devices, components, and systems described herein.

The computer system 600 includes a processor 601. The processor 601 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

### INDUSTRIAL APPLICABILITY

This disclosure generally relates to devices, systems, and methods for providing exercise program recommendations for a user of an exercise device. An exercise program recommendation system may review the exercise program videos used in exercise programs stored in an exercise program library. The exercise program recommendation system may apply a vector search model to the exercise program videos. This may result in vectored features of the exercise program videos. The vectored features may be associated with video features, such as background features, trainer features, and so forth. The exercise program recommendation system may apply a machine learning (ML) personalization model to the exercise program videos to generate a recommended exercise program video for the user to use in a workout. The ML personalization model may utilize the vectored features to determine the recommended exercise program video for the user. In this manner, the recommended exercise program videos may be more relevant and/or more representative of the user's interests and preferences in exercise programs. This may help to improve the exercise experience for the user.

In accordance with at least one embodiment of the present disclosure, the ML personalization model prepares the recommended exercise videos based on user information. For example, the user may login with a user login to an exercise machine with a user profile. The user profile may include an exercise program history, which may be a representation of the completed exercise programs that the user has previously completed. The exercise program history may include the top video features for the user. The exercise program videos from the completed exercise programs may have been vectorized by the vector search model. Using the vector features from the vectorized completed exercise programs, the user profile may include a list vector features from the completed exercise program videos. In some embodiments, the user profile includes a list of common or favorite vector features, such as a count of how many workouts the user performed with an exercise program that included that particular vector features. Using the common or favorite vector features, the ML personalization model may prepare exercise program recommendations for the user using the vector features of the exercise program videos associated with the exercise programs in the exercise program library. In this manner, the recommended exercise programs may include exercise program videos that include vectored features that the user likes or regularly uses. This may facilitate improved recommendations, resulting in increased user engagement with exercise and exercise programs.

In some embodiments, the ML personalization model prepares exercise program recommendations based on a query. For example, the user may enter a query when the user desires to perform a workout on an exercise device. The ML personalization model may identify keywords from the query and recommend exercise programs based on exercise programs that include exercise program videos with exercise features associated with the query keywords. In some embodiments, the query may be an automated search query. For example, when the user logs in to the exercise device, the operating system for the exercise device may send a query to the ML personalization model to prepare an exercise program recommendation based on the user's exercise program history. In this manner, the user may receive exercise program recommendations without actively entering a query. This may facilitate improved engagement in exercise programs and improve the exercise experience.

An exercise program recommendation system may provide exercise program recommendations to a user using an ML personalization model applied to exercise programs that have been vectorized by a vector search model.

The exercise program recommendation system may include one or more exercise devices. The exercise devices may include any type of exercise device, such as a treadmill, an elliptical device, a stationary bicycle, a rower, a cable extension device, a mirror including a backlit display behind a mirrored surface, any other exercise device, and combinations thereof. While specific exercise devices are discussed herein, it should be understood that the techniques of the present disclosure may be applied to any exercise device that is capable of implementing an exercise program.

The exercise program recommendation system may further include an exercise program library. The exercise program library may include a repository of one or more exercise programs. The exercise programs may be implemented on one or more of the exercise devices. Each of the exercise programs may include exercise device controls and an exercise program video.

When the user accesses the exercise program on an exercise device, the exercise program may guide the user through a workout. Throughout the workout, the exercise device controls may adjust one or more operating parameters of the exercise device. The exercise device controls may adjust any operating parameter, such as a flywheel resistance, a belt speed, a device incline, any other operating parameter, and combinations thereof. In some embodiments, the exercise device controls include a duration for one or more portions of the exercise program. For example, the exercise device controls may include a total workout duration for the entire exercise program and/or an interval duration for a period of a particular difficulty level (e.g., resistance level, belt speed, incline level).

The exercise programs may include an exercise program video. The exercise program video may be a video that is associated with the workout. When the user accesses the exercise program on an exercise device, the exercise program video may be displayed on a display of the exercise device. The exercise program video may include any type of video. For example, the exercise program video may include a representation of a trainer that is providing instruction for the user to perform the workout. In some examples, the trainer in the exercise program video may be performing the workout in the exercise program video. In some examples, the exercise program video may include scenery and/or setting images. The scenery may include any type of scenery, such as outdoor scenes, scenes representative of real-world locations, scenes representative of fantasy locations, any other scenery, and combinations thereof. In some embodiments, the scenery and/or setting includes videos. In some embodiments, the scenery and/or setting includes still backgrounds. In some embodiments, the trainer is depicted as being located in front of the scenery. In some embodiments, the trainer is recorded on-site in front of the scenery. In some embodiments, the trainer is recorded remote from the scenery and overlaid in front of the scenery.

The exercise program video may be synchronized with the exercise device controls. For example, the exercise program video may include video features, audio features, or other elements that are synchronized or associated with the exercise device controls. The associations between the exercise program video and the exercise device controls may be based on any portion of the exercise program video. For example, the associations between the exercise program video and the exercise device controls may be based on comments made by the trainer. In some examples, the associations between the exercise program video and the exercise device controls may be based on the operating parameters of the trainer's exercise device. In some examples, the associations between the exercise program video and the exercise device controls may be based on the scenery (e.g., increased incline when a hill is depicted).

In some embodiments, the exercise programs are specifically tailored to a particular exercise device. For example, the exercise programs may be specifically tailored to a type of exercise device, a manufacturer of an exercise device, a particular model of exercise device, and so forth. The exercise device controls may be specific to control the particular exercise device. In some examples, the exercise program video may include features, references, or images depicting a particular exercise device.

In some embodiments, the exercise programs are usable by more than one type of exercise device. For example, an exercise program may include resistance settings for a flywheel, and the exercise program may be usable by any flywheel-based exercise device. In some embodiments, a portion of an exercise program is usable by multiple exercise programs. For example, an exercise program video may include scenery over which a trainer may be overlaid. Different trainers operating different exercise devices and/or performing different exercise activities may be overlaid over the same scenery to make the exercise program video.

In some embodiments, the exercise program library is at least partially stored on the individual exercise devices. For example, one or more of the exercise programs may be stored on memory of the exercise devices. In some embodiments, the exercise program library is stored in memory on a remote computing device, such as a server computing device, a cloud computing system, any other remote computing device, and combinations thereof.

The exercise devices may be in communication with the exercise program library over an exercise network. The exercise network may be any type of network. For example, the exercise network may be a local area network (LAN), a wide area network (WAN), a Wi-Fi network, a cellular network, any other network, and combinations thereof.

The exercise program recommendation system may further include a vector search model. The vector search model may access or receive one or more of the exercise programs from the exercise program library. In some embodiments, the vector search model receives the entirety of the exercise program library, or the entirety of the exercise programs in the exercise program library. The exercise program recommendation system may apply the vector search model to the exercise programs. In accordance with at least one embodiment of the present disclosure, the vector search model vectorizes at least a portion of the exercise programs. The exercise program recommendation system may apply the vector search model to the exercise programs to analyze the content of the exercise programs. In this manner, the exercise program library may include a library of the vectorized content of the exercise programs.

The vector search model may prepare vector embeddings of vector features in the exercise programs. To generate the vector features, the vector search model may be trained on a training dataset including videos tagged with key features or tags. The key features or tags may be relevant to the exercise program videos. For example, the key features or tags may include background features, scenery features, trainer features (e.g., gender, race, intensity), any other vector features of the exercise program videos, and combinations thereof.

When the exercise program recommendation system applies the vector search model to the exercise programs, the vector search model may generate one or more exercise features for each of the exercise programs. In some embodiments, each exercise program includes one vector feature. In some embodiments, each exercise program includes multiple vector features. In some embodiments, the vector features of the exercise programs is ranked based on a prevalence of the vector features within the exercise programs. For example, the vector features may be ranked based on how frequently a particular vector feature is present in the exercise program. In some examples, the vector features may be ranked based on a total duration or a percent duration the particular vector feature is present in the exercise programs. Ranking the vector features may help to indicate the prevalence of the vector features in the exercise program.

The exercise program recommendation system may further include an ML personalization model. The exercise program recommendation system may apply the ML personalization model to user information and/or user queries to generate an exercise program recommendation for the user to perform on a particular exercise device. To generate the exercise program recommendations, the ML personalization model may analyze the exercise programs to determine the similarity of the exercise programs to the queries. For example, the ML personalization model may determine the vector features that are close or similar to the user information and/or the user query. Based on the similarities, the ML personalization model may generate the exercise program recommendation.

The ML personalization model may be any type of personalization model and may utilize any personalization mechanisms to generate the recommendations. For example, the ML personalization model may use collaborative filtering based on the exercise program history of multiple users. This may help to identify patterns between exercise programs that other users may enjoy or desire. In some examples, the ML personalization model may utilize content-based filtering. Content-based filtering may filter the exercise programs based on the vector features in the exercise programs. In some examples, content-based filtering may examine other media with which the user interacts to provide recommendations. In some examples, the ML personalization model may utilize natural language processing to process input queries, conversations, or other natural language provided by the user. In some examples, the ML personalization model may utilize A/B testing to determine the effectiveness of different recommendation strategies. In some embodiments, the ML personalization model incorporates contextual information to provide recommendations, such as time of day, time of year, type of exercise device, workout intensity history, user location, user proximity to other users, any other contextual information, and combinations thereof. In some examples, the ML personalization model may be a trainable ML model trained based on user ratings of exercise programs. In some examples, the ML personalization model may utilize a combination of two or more of the techniques discussed herein.

In some embodiments, the ML personalization model generates a single exercise program recommendation. For example, the ML personalization model may generate the exercise program recommendation that the ML personalization model determines is the best fit for the user. In some embodiments, the ML personalization model generates multiple exercise program recommendations. For example, the ML personalization model may generate a plurality of exercise program recommendations based on a minimum threshold of similarity to the query or user information. In some embodiments, the ML personalization model generates a ranking for each exercise program recommendation. The ranking may be a similarity recommendation. For example, the ranking may be a representation of how similar the exercise program recommendation is to a previously performed exercise program. In some embodiments, the ranking is a projected interest ranking. For example, the ranking may be a representation of a projected ranking or enjoyment of the recommended exercise program. In some embodiments, the ranking is based on the vector features, including the similarity of the vector features to the user information and/or the user query.

The ML personalization model may provide the exercise program recommendation to the user on the exercise device. In some embodiments, the ML personalization model provides the exercise device with the exercise program recommendation and the exercise device may provide the exercise program recommendation to the user on a display of the exercise device.

In some embodiments, the exercise program recommendation system implements the recommended exercise program I 06 on the exercise device. In some embodiments, the user selects the recommended exercise program, and upon receiving the selection of the exercise program, the exercise program recommendation system may implement the recommended exercise program on the exercise device. The user may then perform the workout on the exercise device using the recommended exercise programs.

Each of the components of the exercise program recommendation system can include software, hardware, or both. For example, the components can include one or more instructions stored on a computer-readable storage medium and executable by processors of one or more computing devices, such as a client device or server device. When executed by the one or more processors, the computer-executable instructions of the exercise program recommendation system can cause the computing device(s) to perform the methods described herein. Alternatively, the components can include hardware, such as a special-purpose processing device to perform a certain function or group of functions. Alternatively, the components of the exercise program recommendation system can include a combination of computer-executable instructions and hardware.

Furthermore, the components of the exercise program recommendation system may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

The exercise program recommendation system includes an exercise program library. The exercise program library includes a storage of exercise programs that may be implemented on an exercise device, as discussed above with respect to the exercise program library. The exercise program library may further include available exercise programs. The available exercise programs may be exercise programs that are available to the user. For example, the available exercise programs may include exercise programs that are available to the user based on a subscription plan of the user. In some examples, the available exercise programs may be device-specific exercise programs, or exercise programs that are available to the user based on the user's exercise device. In some examples, the available exercise programs may be available to the user in any other manner.

The exercise program recommendation system may further include a vector search model. The vector search model may vectorize one or more of the exercise programs in the exercise program library. The vector search model may generate vector features of the exercise programs based on any exercise program feature. For example, the vector search model may generate vector features based on background features of the exercise program video. In some examples, the vector search model may generate the vector features based on trainer features of the trainer featured in the exercise program video. In some examples, the vector search model may generate the vector features based on exercise parameter features, such as exercise program length, difficulty, average resistance, average incline, heart rate targets, any other exercise parameter feature, and combinations thereof.

The exercise program recommendation system may include an ML personalization model. As discussed herein, the ML personalization model may generate personalized recommendations for the user based on the vectorized exercise programs.

A query manager may receive and manage queries for exercise programs. For example, the query manager may receive an input query input by the user. The input query may be an express input from the user. For example, the user may provide an input to the exercise device or other computing device for exercise programs having one or more particular features. The query manager may provide the ML personalization model with the input query, and the ML personalization model may generate a personalized recommendation to the user based on the query. For example, the ML personalization model may identify exercise features within the query, and may generate the exercise program recommendation to include exercise programs that are similar to the exercise features in the query. In some embodiments, the query is a query for a new exercise program. For example, the new exercise program may be an exercise program that the user has not completed. In some examples, the new exercise program may be an exercise program that includes a new features, or features not included in completed exercise programs.

As a specific, non-limiting example, the query manager may receive an input query from a user on a treadmill where the user states “I would like to go for a run in the mountains.” The ML personalization model may identify that the query is for a treadmill and that the user desires to have features in the exercise program video related to mountains. As discussed herein, the vector search model may identify vector features of the exercise programs. The vector features may include exercise program features such as exercise program videos that include mountains, hills, scenic views. The ML personalization model may provide exercise program recommendations based on the exercise programs that have vector features related to mountains.

In some embodiments, the ML personalization model generates the exercise program recommendation based on exercise programs of other users who engage in exercise programs with exercise features having mountains. Such exercise program recommendations may include features related to mountains, but may not include mountains themselves. For example, users that engage in exercise programs with exercise features having mountains may also engage in exercise programs with exercise features having forests. Based on this correlation, the ML personalization model may generate exercise program recommendations that include forested exercise features.

In some embodiments, the ML personalization model generates the exercise program recommendation based at least partially on a user exercise program history. The user exercise program history may include a record of the exercise programs performed by the user. For example, the user exercise program history may include a record of each exercise program performed by the user, the date and time the exercise program was performed, the user's rating and other notes about the workout, the user's rating of the exercise program, user parameters related to the exercise programs (e.g., heartrate, cadence), vector features of the exercise program, any other exercise program information, and combinations thereof. The user exercise program history may include top video features. In some embodiments, the top video features include video features that are commonly present in the exercise programs of the user exercise program history. In some embodiments, the top video features include video features that are highly rated and/or video features that are present in highly rated exercise programs. In some embodiments, the top video features may include any video feature in the exercise programs from the user exercise program history.

The ML personalization model may generate the exercise program recommendations based at least on part on the user exercise program history. For example, the ML personalization model may generate the exercise program recommendations based the most common vector features present in the user exercise program history. In some examples, the ML personalization model may generate the exercise program recommendations based on the highest rated exercise programs. In some examples, the ML personalization model may generate the exercise program recommendations based when previously completed exercise programs were performed. For example, the ML personalization model may generate an exercise program recommendation for a lower-intensity exercise program if the user recently completed a higher-intensity exercise program. In this manner, the ML personalization model may generate more relevant and/or more representative exercise program recommendations, thereby improving the exercise experience.

In accordance with at least one embodiment of the present disclosure, the query manager may generate a query for the ML personalization model based on the user exercise program history. For example, when the user logs into the exercise device, the query manager may review the user exercise program history and generate a query to exercise programs similar to the previously completed exercise programs. The query manager may automatically provide the query to the ML personalization model, and the ML personalization model may generate the recommendation. In this manner, the exercise program recommendation system may generate exercise program recommendations without user input.

The exercise program recommendation system may rank the exercise program recommendations. In some embodiments, the ML personalization model provides a ranking for the exercise program recommendations. For example, as discussed herein, the ML personalization model may provide a ranking for the exercise program recommendation, such as a similarity ranking and/or a projected interest ranking. In some embodiments, an exercise program rank manager prepares the ranking. In some embodiments, the exercise program rank manager receives a plurality of exercise program recommendations and the exercise program rank manager may rank the plurality of exercise recommendations.

An exercise program library may include a repository of exercise programs. A vector search model may be applied to the exercise programs. As discussed herein, the vector search model may vectorize the exercise programs to generate the vector features of the exercise programs.

The exercise program recommendation system may further include a ML personalization model. The ML personalization model may receive the exercise programs and/or the vector features of the exercise programs.

When the user desires to begin a workout, the user may log into or otherwise access an exercise device. The exercise device may provide a query to the ML personalization model. As discussed herein, the query may include any type of query. For example, the user may provide an input to the exercise device. In some examples, the exercise device may generate an input based on user information and/or user exercise program history.

The ML personalization model may receive the query. The ML personalization model may process the query and prepare one or more exercise program recommendations. The ML personalization model may send the exercise program recommendations to the exercise device.

The exercise device may receive the one or more exercise program recommendations. Based on the exercise program recommendations, the exercise device may implement the exercise program associated with the exercise program recommendations. For example, the exercise device may cause the exercise device to display the video portion of the exercise program and to adjust the operating parameters of the exercise device based on the exercise device controls. In some embodiments, the user selects one of the exercise program recommendations and the exercise device may implement the exercise program associated with the selected exercise program recommendation.

An exercise program recommendation system may apply a vector search model to a plurality of exercise program videos. The vector search model may identify vector features within the plurality of exercise program videos. For example, the vector search model may identify vector features related to video features in the exercise program videos. The exercise program videos may be associated with exercise programs. For example, an exercise program video may be displayed during the execution of an exercise program.

The exercise program recommendation system may receive a search query for an exercise program. The search query may include an exercise program feature. For example, the search query may include an input query using input from the user, and the input query may include a request for a particular exercise program feature. In some examples, the search query may be an automatic search query that is generated based on user exercise information in the user exercise program history. The exercise program features in the search query may include any exercise program features, such as background features of an exercise program video, exercise intensity, trainer features, prior workouts performed, user exercise program ratings, any other exercise program features, and combinations thereof.

Based on the exercise program feature in the search query, the exercise program recommendation system may apply an ML personalization model to the plurality of exercise program videos. The ML personalization model may sort the exercise programs based on the query and using the vector features. The ML personalization model may generate an exercise program recommendation. For example, the ML personalization model may generate the exercise program recommendation from the plurality of exercise program videos. The exercise program recommendation system may provide the user with the exercise program recommendation from the plurality of exercise program videos.

In accordance with at least one embodiment of the present disclosure, the exercise program recommendation system implements or causes to be implemented the exercise program recommendation on an exercise device. For example, the user may select the recommended exercise program and the exercise device may implement the recommended exercise program on the exercise device.

In some embodiments, the exercise program recommendation includes a plurality of exercise program recommendations. For example, the ML personalization model may generate a plurality of exercise program recommendations based on the query and using the vectored features. The ML personalization model may generate multiple exercise program recommendations and the exercise program recommendation system may provide the exercise program recommendations to the user. In some embodiments, the user selects one of the recommended exercise programs and the exercise program recommendation system may cause the selected exercise program to be implemented on the exercise device.

In some embodiments, the ML personalization model generates the exercise program recommendation using a user exercise program history. The user exercise program history may include historical exercise information for the user. In some embodiments, the user exercise program history includes top video features from previously performed or completed exercise programs.

In some embodiments, the ML personalization model identifies correlations between the vector features and user popularity. The user popularity may be the popularity of the exercise programs as indicated by how frequently the exercise program is performed by other users and/or the number of other users that have performed a particular exercise program. In some embodiments, the ML personalization model generates the exercise program recommendation based on the vector features and the user popularity.

In some embodiments, when generating the vector features, the vector search model utilizes pre-determined vector features. For example, as discussed herein, the vector search model may be trained using the pre-determined vector features. Applying the vector search model to the based on the pre-determined vector features. This may cause the vector search model to generate the vector features for the exercise program library that correlate to and/or include the pre-determined vector features.

In some embodiments, the exercise program recommendation system gathers a set of exercise program videos and the ML personalization model may prepare the exercise program recommendation based on the gathered set of exercise. For example, the exercise program recommendation system may gather the set of exercise program videos and the exercise program recommendation system may apply the ML personalization model to the gathered set of exercise program videos.

The exercise program recommendation system may gather the exercise program videos using any gathering parameter. For example, the exercise program recommendation system may gather the set of exercise program videos based on an intensity level of the exercise program videos. In some examples, the exercise program recommendation system may gather the set of exercise program videos based on trainer information, such as a trainer identity. In some examples, the exercise program recommendation system may gather the set of exercise program videos based on exercise program availability. The exercise program availability may be a representation of whether a particular user may have access to a particular exercise program. For example, the exercise program availability may be based on a subscription of the user. In some examples, the exercise program availability may be based on the exercise device, including the type of exercise device, the make of the exercise device, the model of the exercise device, any other exercise device information, and combinations thereof. In some examples, the exercise program recommendation system may gather the set of exercise program videos based on a compatibility with a training plan for the user. For example, the training plan for the user may include particular workout types that are to be performed on particular days, such as recovery days, high-intensity days, cross-training days, any other training plan information, and combinations thereof. In some examples, the exercise program recommendation system may gather the set of exercise program videos based on uncompleted exercise programs, or exercise programs that the user has not completed.

The exercise program recommendation system may receive a plurality of exercise programs from an exercise library. The plurality of exercise programs may include video features of exercise program videos associated with the plurality of exercise programs. The exercise program recommendation system may apply a vector search model to the plurality of exercise program videos. The vector search model may generate vector features for the video features of the exercise program videos.

The exercise program recommendation system may identify top video features from a user exercise program history. For example, as discussed herein, the exercise program recommendation system, including the ML personalization model, may identify the top video features based on any metric, such as number of views/uses, video ranking, any other metric, and combinations thereof.

n some embodiments, the exercise program recommendation system applies an ML personalization model to the plurality of exercise program videos to generate a recommended exercise program from the plurality of exercise programs based on the top video features.

As discussed herein, the exercise program recommendation system may implement the recommended exercise program associated with the exercise program recommendation on an exercise device. In some embodiments, the video features of the exercise program videos include video background features. The video background features may be background features of the exercise program video associated with a particular exercise program. In some embodiments, the ML personalization model generates the vector features for the video background features. In some embodiments, the top video features include top background features, and identifying the top video features includes identifying the top background features.

As discussed herein, in some embodiments, identifying the top video features includes identifying the top video features based on common video features in the user exercise program history. In some embodiments, identifying the top video features includes identifying the top video features based on a completion frequency of the completed exercise programs in the user exercise program history.

In some embodiments, the user exercise program history includes negative video features. In some embodiments, the negative video features are based on any metric, such as uncompleted exercise programs, low user-rankings of exercise programs, user reviews, any other metric, and combinations thereof.

One or more computer systems may be used to implement the various devices, components, and systems described herein. The computer system includes a processor. The processor may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor may be referred to as a central processing unit (CPU). Although just a single processor is described herein, in an alternative configuration, a combination of processors (e.g., an ARM and DSP) could be used.

The computer system also includes memory in electronic communication with the processor. The memory may be any electronic component capable of storing electronic information. For example, the memory may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions and data may be stored in the memory. The instructions may be executable by the processor to implement some or all of the functionality disclosed herein. Executing the instructions may involve the use of the data that is stored in the memory. Any of the various examples of modules and components described herein may be implemented, partially or wholly, as instructions stored in memory and executed by the processor. Any of the various examples of data described herein may be among the data that is stored in memory and used during execution of the instructions by the processor.

A computer system may also include one or more communication interfaces for communicating with other electronic devices. The communication interface(s) may be based on wired communication technology, wireless communication technology, or both. Some examples of communication interfaces include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system may also include one or more input devices and one or more output devices. Some examples of input devices include a keyboard, mouse, microphone, remote control device, button, joystick, trackball, touchpad, and lightpen. Some examples of output devices include a speaker and a printer. One specific type of output device that is typically included in a computer system is a display device. Display devices used with embodiments disclosed herein may utilize any suitable image projection technology, such as liquid crystal display (LCD), light-emitting diode (LED), gas plasma, electroluminescence, or the like. A display controller may also be provided, for converting data stored in the memory into text, graphics, and/or moving images (as appropriate) shown on the display device.

The various components of the computer system may be coupled together by one or more buses, which may include a power bus, a control signal bus, a status signal bus, a data bus, etc.

Following are sections in accordance with at least one embodiment of the present disclosure:
A1. A method for generating exercise program recommendations, the method comprising:
applying a vector search model to a plurality of exercise program videos, the vector search model identifying vector features within the plurality of exercise program videos;
receiving a search query for an exercise program, the search query including an exercise program feature;
based on the exercise program feature, applying a machine learning (ML) personalization model to the plurality of exercise program videos; and
providing a user with an exercise program recommendation from the plurality of exercise program videos.

A2. The method of section A1, further comprising implementing a recommended exercise program associated with the exercise program recommendation an exercise device.
A3. The method of section A1 or A2, wherein the exercise program recommendation includes a plurality of exercise program recommendations, and wherein providing the user with the exercise program recommendation includes providing the user with the plurality of exercise program recommendations.
A4. The method of section A3, further comprising:
receiving a selection of a selected exercise program of the plurality of exercise program recommendations; and
implementing the selected exercise program on an exercise device.
A5. The method of any of sections A1-A4, wherein applying the ML personalization model includes applying the ML personalization model based on the exercise program feature.
A6. The method of any of sections A1-A5, wherein applying the ML personalization model includes applying the ML personalization model based on user exercise program history from the user.
A7. The method of section A6, wherein the user exercise program history includes completed exercise programs.
A8. The method of section A7, wherein applying the ML personalization model includes applying the ML personalization model based on top video features from the completed exercise programs.
A9. The method of any of sections A1-A8, wherein the ML personalization model generates the exercise program recommendation based on identifying a correlation between the vector features and user popularity.
A10. The method of any of sections A1-A9, wherein the vector features are pre-determined vector features, and wherein applying the vector search model includes applying the vector search model based on the pre-determined vector features.
A11. The method of any of sections A1-A10, wherein receiving the search query includes receiving the search query from a user input.
A12. The method of any of sections A1-A11, wherein receiving the search query includes receiving the search query from user exercise information.
A13. The method of section A12, wherein the user exercise information includes prior workouts performed.
A14. The method of section A12 or A13, wherein the user exercise information includes user exercise program ratings.
A15. The method of any of sections A1-A14, wherein receiving the search query includes receiving an automated search query based on operating an exercise device.
A16. The method of any of sections A1-A15, further comprising gathering a set of exercise program videos from the plurality of exercise program videos, and wherein applying the ML personalization model to the set of exercise program videos.
A17. The method of section A16, wherein gathering the set of exercise program videos includes gathering the set of exercise program videos based on an intensity level.
A18. The method of section A16 or A17, wherein gathering the set of exercise program videos includes gathering the set of exercise program videos based on a trainer identity.
A19. The method of any of sections A16-A18, wherein gathering the set of exercise program videos includes gathering the set of exercise program videos based on exercise program availability.
A20. The method of any of sections A16-A19, wherein gathering the set of exercise program videos includes gathering the set of exercise program videos compatible with a training plan.
A21. The method of any of sections A16-A20, wherein gathering the set of exercise program videos includes gathering the set of exercise program videos based on uncompleted exercise programs.
B1. A method for generating exercise program recommendations, the method comprising:
receiving a plurality of exercise programs from an exercise program library, the plurality of exercise programs including video features of exercise program videos associated with the plurality of exercise programs;
applying a vector search model to the plurality of exercise programs, the vector search model generating vector features for the video features;
identifying top video features from a user exercise program history; and
applying a machine learning (ML) personalization model to the plurality of exercise programs to generate an exercise program recommendation from the plurality of exercise programs based on the top video features.
B2. The method of section B1, further comprising implementing a recommended exercise program associated with the exercise program recommendation on an exercise device.
B3. The method of section B1 or B2, wherein applying the ML personalization model to the plurality of exercise programs to generate a recommended exercise program includes generating a plurality of exercise program recommendations.
B4. The method of section B3, further comprising:
receiving a selection of a selected exercise program from the plurality of exercise program recommendations; and
implementing the selected exercise program on an exercise device.
B5. The method of any of sections B1-B4, wherein the video features include video background features.
B6. The method of section B5, wherein generating the vector features includes generating the vector features for the video background features.
B7. The method of section B6, the top video features includes top background features, and wherein identifying the top video features includes identifying the top background features.
B8. The method of any of sections B1-B7, wherein identifying the top video features includes identifying the top video features based on common video features in the user exercise program history.
B9. The method of any of sections B1-B8, wherein the user exercise program history includes completed exercise programs completed by a user.
B10. The method of section B9, wherein identifying the top video features includes identifying the top video features based on a completion frequency of the completed exercise programs.
B11. The method of any of sections B1-B10, wherein the user exercise program history includes negative video features.
B12. The method of section B11, wherein the negative video features are from uncompleted exercise programs not completed by a user.
B13. The method of section B11 or B12, wherein applying the ML personalization model includes excluding the negative video features.
B14. The method of any of sections B1-B13, wherein the exercise program recommendation includes at least one of the top video features.
B15. The method of any of sections B1-B14, wherein the exercise program recommendation includes a similar video feature to at least one of the top video features.
B16. The method of any of sections B1-B15, wherein receiving the plurality of exercise programs includes receiving an entirety of the exercise program library.
B17. The method of any of sections B1-B16, wherein receiving the plurality of exercise programs includes receiving the plurality of exercise programs usable by a type of exercise device.
B18. The method of any of sections B1-B17, further comprising receiving a query for a new exercise program, and wherein receiving the plurality of exercise programs includes receiving the plurality of exercise programs based on the query.
B19. The method of any of sections B1-B18, wherein receiving the query for the new exercise program includes receiving the query based on user input.
B20. The method of section B19, wherein receiving the query for the new exercise program includes receiving the query based on a user login to an exercise device.
C1. Any device, apparatus, system, kit, component, or subcomponent as illustrated or described, or method of manufacture or use thereof.
D1. A method having any or each permutation of features recited in sections A1-A21 and B1-B20.
E1. An assembly/system/device having any or each permutation of features recited in A1-A21 and B1-B20.
F1. Any system, assembly, component, subcomponent, process, element, or portion thereof, as described or illustrated.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for generating exercise program recommendations, comprising:
applying a vector search model to a plurality of exercise programs, wherein the vector search model identifies vector features within the plurality of exercise programs;
receiving a search query for an exercise program, the search query comprising an exercise program feature;
applying, based at least in part on the exercise program feature, a machine learning (ML) personalization model to the plurality of exercise programs; and
providing a user with an exercise program recommendation from the plurality of exercise programs.

2. The method of claim 1, further comprising:
implementing a recommended exercise program associated with the exercise program recommendation at an exercise device.

3. The method of claim 1, wherein applying the ML personalization model comprises:
applying the ML personalization model based at least in part on the exercise program feature.

4. The method of claim 1, wherein applying the ML personalization model comprises:
applying the ML personalization model based at least in part on a user exercise program history associated with the user.

5. The method of claim 1, further comprising:
generating, by the ML personalization model, the exercise program recommendation based at least in part on identifying a correlation between the vector features and a popularity associated with one or more other users.

6. The method of claim 1, wherein the vector features are pre-determined vector features, and wherein applying the vector search model comprises:
applying the vector search model based at least in part on the pre-determined vector features.

7. The method of claim 1, wherein receiving the search query comprises:
receiving the search query from exercise information associated with the user.

8. The method of claim 1, further comprising:
determining a set of one or more exercise programs from the plurality of exercise programs, wherein applying the ML personalization model comprises:
applying the ML personalization model to the set of one or more exercise programs.

9. The method of claim 8, wherein determining the set of one or more exercise programs comprises:
determining the set of one or more exercise programs based at least in part on an intensity level, a trainer identity, exercise program availability, compatibility with a training plan, uncompleted exercise programs, or any combination thereof.

10. A method for generating exercise program recommendations, comprising:
receiving a plurality of exercise programs from an exercise program library, the plurality of exercise programs including video features of exercise programs associated with the plurality of exercise programs;
applying a vector search model to the plurality of exercise programs, wherein the vector search model generates one or more vector features for the video features;
identifying one or more top video features from a user exercise program history; and
applying a machine learning (ML) personalization model to the plurality of exercise programs to generate an exercise program recommendation from the plurality of exercise programs based at least in part on the one or more top video features.

11. The method of claim 10, wherein applying the ML personalization model comprises:
generating a plurality of exercise program recommendations.

12. The method of claim 11, further comprising:
receiving a selection of a selected exercise program from the plurality of exercise program recommendations; and
implementing the selected exercise program on an exercise device.

13. The method of claim 10, wherein the video features include video background features.

14. The method of claim 13, wherein applying the vector search model comprises:
generating, by the vector search model, the one or more vector features for the video background features.

15. The method of claim 10, wherein identifying the one or more top video features comprises:
identifying the one or more top video features based at least in part on common video features associated with the user exercise program history.

16. The method of claim 10, wherein the user exercise program history comprises one or more negative video features.

17. The method of claim 16, wherein applying the ML personalization model comprises:
excluding the one or more negative video features.

18. The method of claim 10, wherein the exercise program recommendation comprises at least one of the one or more top video features.

19. An exercise program recommendation system, comprising:
an exercise device comprising a display; and
a processor and memory, the memory including instructions executable by the processor to cause the exercise program recommendation system to:
apply a vector search model to a plurality of exercise programs, wherein the vector search model identifies vector features within the plurality of exercise programs;
receive a search query for an exercise program, the search query comprising an exercise program feature;
apply, based at least in part on the exercise program feature, a machine learning (ML) personalization model to the plurality of exercise programs; and
provide, via the display, a user with an exercise program recommendation from the plurality of exercise programs.

20. The exercise program recommendation system of claim 19, wherein the exercise device includes an operating feature, and wherein the plurality of exercise programs include exercise device controls configured to adjust the operating feature.
